(19) United States
(12) Patent Application Publication
(10) Pub. No.: US 2018/0075505 A1
(43) Pub. Date: Mar. 15, 2018

(54) Expedited Greeting Cards

(71) Applicant: Richard Eugene Hays, Topeka, KS (US)

(72) Inventor: Richard Eugene Hays, Topeka, KS (US)

(21) Appl. No.: 15/205,267

(22) Filed: Jul. 8, 2016

Related U.S. Application Data
(60) Provisional application No. 62/231,519, filed on Jul. 9, 2015.

(51) Int. Cl. G06Q 30/06; G06Q 10/08; G06K 15/02

(52) U.S. Cl. CPC G06Q 30/0621; G06K 2215/0097; G06K 15/021; G06Q 10/083

(57) ABSTRACT

A system and method for overall expedited selection, personalization, transmission and delivery of traditional retail greeting cards. The system supports access by internet enabled devices to a database of stored greeting card images for the sender's selection, entry of personal Greeting/Message and Closing & Signature. A script font is selected to display and print entered text. Following entry of all address information and successful payment, a Card Record file containing key data is immediately transmitted and received at the designated Retail Card/Print Facility located in close proximity to the card recipient's zip code. The selected greeting card and associated envelope are retrieved and printed with the text data identified for each. Completed cards are inserted in the addressed envelope, sealed and grouped by To zip code, and either collected by the local postal carrier, on their normal route, or delivered directly to the USPS Network Distribution Center (NDC). Following processing at the NDC, the greeting card is transported to the recipient's local post office for delivery.

### FIELD OF INVENTION

The present invention is directed to a method and system, using existing technology to expedite the entire process of selecting, personalizing and sending standard retail greeting cards to a recipient in the most efficient manner possible.

### BACKGROUND OF THE INVENTION

Pre-printed greeting cards were first developed and marketed in the U.S in the early 1800's. Their original focus, which remains today, was to deliver an expression of love, joy, celebration, gratitude, sorrow and in some cases humor. The most recent statistics from the Greeting Card Association show that American consumers purchase around 13 million greeting cards every day. Although not all greeting cards are sent through the U.S. mail, a significant number are handled by the United States Postal Service (USPS) six days a week. The U.S. Postal Service over the years has introduced numerous inducements for mailers to include 5-digit zip codes, then 9-digit zip codes presorted mail and bar codes. These have all been implemented in an effort to streamline the processing of the mail and maintain reasonable delivery expectations. Even with these new methods and a great deal of automation within the postal service operations, mail delivery times have not improved, but rather have in most cases been extended.

The process of sending greeting cards today involves a variety of time-consuming steps; from going to the retail store to find the right card(s), to purchasing postage and perhaps dropping the card off at the local post office in an attempt to reduce the delivery time. These are the time-consuming steps the card sender has some control over, however it's generally after we turn the card over to the Postal Service where the pick-up, multiple sorting, handling and transporting of the card requires most of the time. Although most consumers have memorized or marked on the calendar the really important dates, since we celebrate them each and every year. However, there are many times when the priorities of work, family activities and our very busy schedules leave little time to shop for, sign, address, obtain postage and mail an important greeting card. We are also faced with the dilemma of how many days in advance must we mail a greeting card for it to reach the recipient on or before the important date. With the increased volume of mail coupled with the seemingly constant consolidation of Postal Service facilities, mail is handled, processed and transported even more today prior to reaching its final destination. So, it is almost impossible for the average consumer to estimate how many days in advance they must mail a greeting card, for it to reach the destination on the desired date.

Therefore, timing is a very critical element in our wish to acknowledge a birthday, anniversary, graduation or some other significant event in a timely manner. With that in mind, each weekday and Saturday we normally have one opportunity for the postman to pick up our mail at our home or business. If we miss that pickup, we may be able to drop our mail at a USPS drop box, but those are generally picked up by 5:30 pm. Although some postal service back-office operations may function 24 hours, 6 days a week, if you miss these local mail pickups, that will result in at least one day added to the delivery date.

With the evolution of the internet and the emergence of E-Mail and Electronic greeting Cards, known as E-Cards, some consumers have found these provide a faster and somewhat easier method of sending greetings to friends and loved ones. However, neither of these electronic methods can convey the warmth and genuine feeling of a paper greeting card. Also with E-Cards comes the threat and real possibility of computer viruses and other malware, which can cause serious problems and expense to those whose systems become infected. This real and ongoing threat has somewhat stunted the growth and use of E-Cards.

There have been numerous other developments in the areas of user created custom greeting cards, with personalized text, pictures and in some cases audio. These approaches, although creative, only add to the time element in getting a card to the recipient by a certain date. In all cases, the completed card(s) is either returned to the customer for mailing or mailed for the customer from a print facility located somewhere in the U.S. In either case all of these approaches face the same issue, with the lengthy time required for mail handled completely by the U.S. Postal system, requiring 4 to 6 days for delivery.

Although E-Cards, E-Mail and some social media applications, such as Face Book provide alternatives to the traditional paper greeting card, they require the recipient to have certain devices and/or software in order to access or receive media from these new technologies. Some traditionalist's insist that these new approaches also lack the same warmth and feeling for both sender and recipient that have always been present with the paper greeting card. For those who cherish and like to hold onto all the special cards from loved ones and family members, only the time-honored paper greeting card can be kept and treasured in later years.

### SUMMARY OF THE INVENTION

The present invention discloses the system and methods, which overcome the disadvantages, limitations and time-consuming elements discussed above. These include purchase of standard retail greeting cards and postage by the sender, personalizing of the card and envelope, as well as numerous requirements for handling, sorting and transporting by the Postal Service through delivery to the card recipient.

In one aspect, the card buyer has access from a multitude of internet enabled devices which provides: a) viewing of and selection from a plurality of greeting card images, identified with a unique Card-ID, from an image database ordered by special occasion categories; b) selection of a script font and entry of a Greeting/Message and Closing & Signature; c) entry of the complete From and To Names, Addresses and Zip Codes; d) display of pricing and entry of payment information. A “Card Record file” consisting of the data elements from preceding a, b, c, d, is stored in the Card Record Database and ready for transmission to a Retail Card/Print Facility.

In another aspect, the To address Zip Code from the Card Record file is used to search the Retail Card/Print Facility & Zip Code Database 106 to determine the appropriate Retail Card/Print Facility, nearest the USPS Network Distribution Center. The Card Record file 104 is transmitted via the internet, or other data network, to the designated Retail Card/Print Facility located in close proximity to the regional USPS Network Distribution Center (NDC) which services the To Zip Code. Upon receipt of the Card Record file 104 the standard retail greeting card and envelope corresponding to the Card-ID selected by card buyer, are retrieved for printing. The open greeting card is inserted into the printer where the personalized Greeting/Message and Closing & Signature are printed using the selected script font. The associated envelope is inserted in the printer whereby the To and From addresses, postage are printed on the envelope. The completed greeting card is inserted in the envelope and sealed.

Currently, the U.S. Postal Service maintains 22 Network Distribution Centers throughout the U.S. These centers are strategically located near large U.S. cities, and each NDC serves as the sorting and distribution point for specific zip codes. All mail coming from or going to local post offices, are processed in one or more NDC. Therefore, all mail in the U.S. passes through at least one NDC in order to reach the local post office and ultimately the recipient. For this reason, NDC's play a critical part in the movement of mail within the U.S. For that reason completed greeting cards are grouped by To zip code and either delivered directly to the Regional USPS-NDC or picked up by the local Postal Carrier during their normal route. After processing, greeting cards are sent from the USPS-NDC to the local Post Office for delivery to the card recipient.

A major advantage of the present invention is once the user has selected the desired greeting card, entered all the text data and completed payment, the Card Record file is transmitted and received at the Retail Card/Print Facility in close proximity to the U.S. Postal Service Network Distribution Center that services the card recipient's zip code. Transmission occurs in a timeframe similar to that of standard email. This eliminates all the usual front end shopping, postal service handling, sorting and transporting, which can take 3 to 5 days, which will instead take mere minutes using the proposed invention.

Another advantage of the present invention is greeting cards can be purchased, completed and sent using most internet enabled devices, regardless of time of day or location, as long as an internet or wi-fi connection is available. This can be done with very little disruption in your schedule, your activities or the need to travel to a retail outlet or post office.

Another significant advantage of the present invention is a person traveling down the highway might recall an event or occasion, which needed to be recognized with a greeting card. Their spouse or traveling companion can accomplish the task regardless of the time of day or day of the week, with his/her smart phone while continuing your 70 mph trip. The same applies being out of town in a hotel or at work. Again, regardless of time of day, day of week or location, as long as there is a wi-fi signal an Expedited Greeting Card can be sent with very little effort.

### BRIEF DESCRIPTION OF THE DRAWINGS

For a more complete understanding of the present invention, and advantages thereof, reference is now made to the following descriptions taken in conjunction with the accompanying drawings, in which:

FIG. 1 Illustrates user access by internet capable devices to the website application with interaction to key databases;

FIG. 2 Illustrates an embodiment of user interaction, describing screen displays and prompts which define greeting card preferences and user selection;

FIG. 3 Illustrates an embodiment of user interaction, describing screen displays and prompts which capture and store information necessary for creation and transmission of a Card-Record file to the appropriate Retail Card/Print Facility;

FIG. 4 Illustrates the embodiment of Card-Record file receipt in the selected Retail Card/Print Facility and the printing of the chosen greeting card and envelope, with subsequent delivery to the regional USPS-NDC (Network Distribution Center);

FIG. 5 Illustrates receipt of completed greeting cards for all zip codes served by the USPS Network Distribution Center, with processing and subsequent distribution to local post offices for delivery to card recipients;

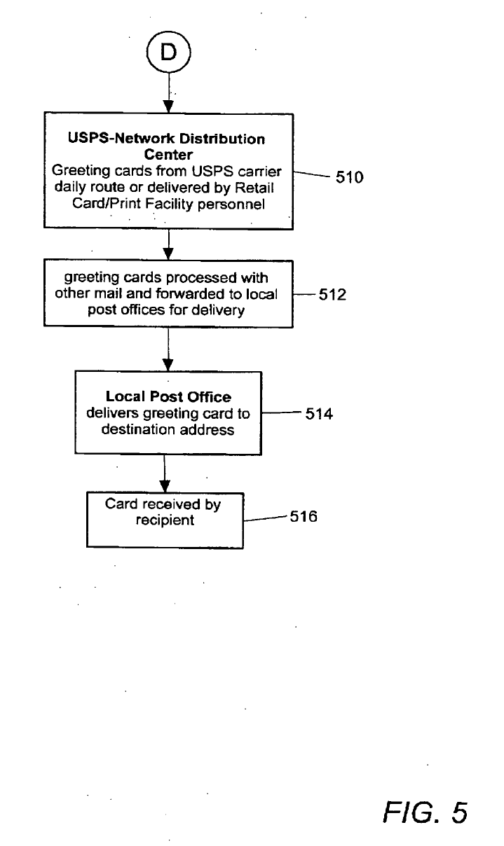

FIG. 6 illustrates the inside of a completed greeting card, reflecting the user submitted text printed in the selected script font;

FIG. 7 Illustrates the completed envelope reflecting the printed To and From addresses, Zip codes, U.S. postage.

### DETAILED DESCRIPTION

The present invention provides a method and system to expedite the selection, personalizing, data transmission, printing and delivery of selected greeting cards to specific card recipients. Although there are other systems and methods allowing the full creation of greeting cards with inclusion of creative graphics and photos, these providers remain almost completely reliant upon the U.S. Postal Service for end to end handling, which in many cases requires 4 to 6 days for delivery to either the card purchaser or recipient.

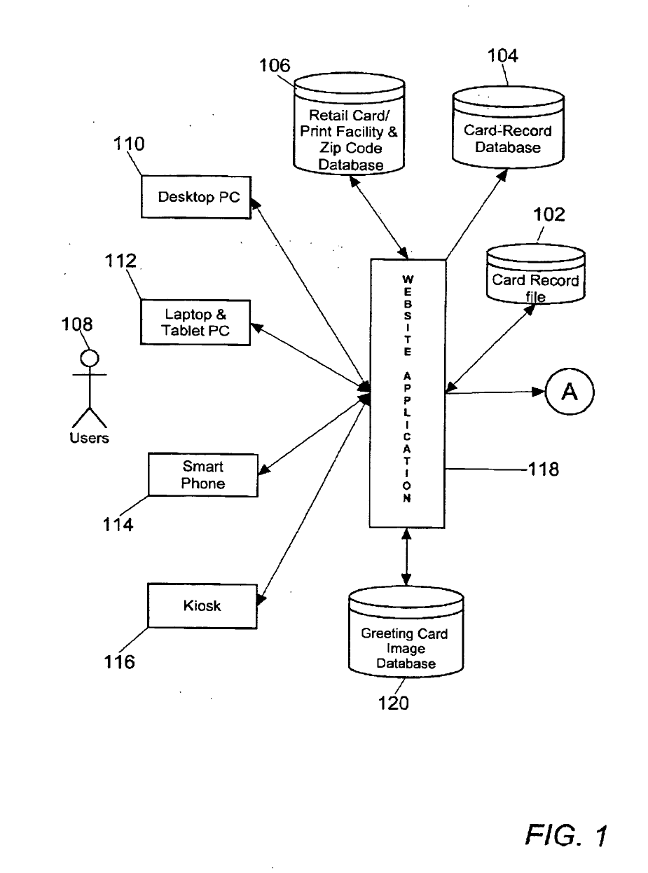

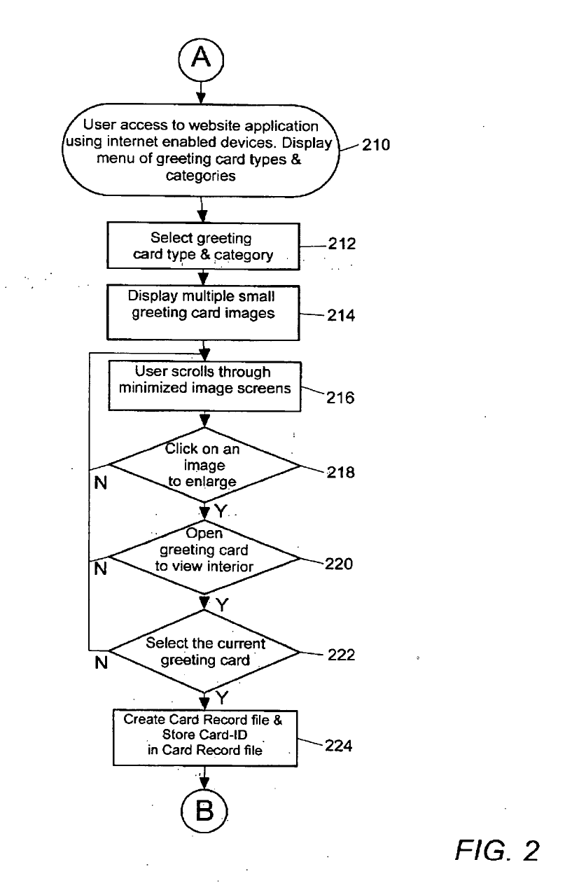

With reference to FIG. 1 and FIG. 2, block diagrams shown representing Users 108 access by use of internet enabled devices (110-116), 210 to the Website Application 118 providing menu query access and selection functions 212 to a Greeting Card Image Database 120 containing a plurality of selected greeting card images. Greeting card query results are progressively displayed 214 as multiple small images on the user's 108 screen (110-116), while the user 108 scrolls available images 216 to select an appropriate greeting card.

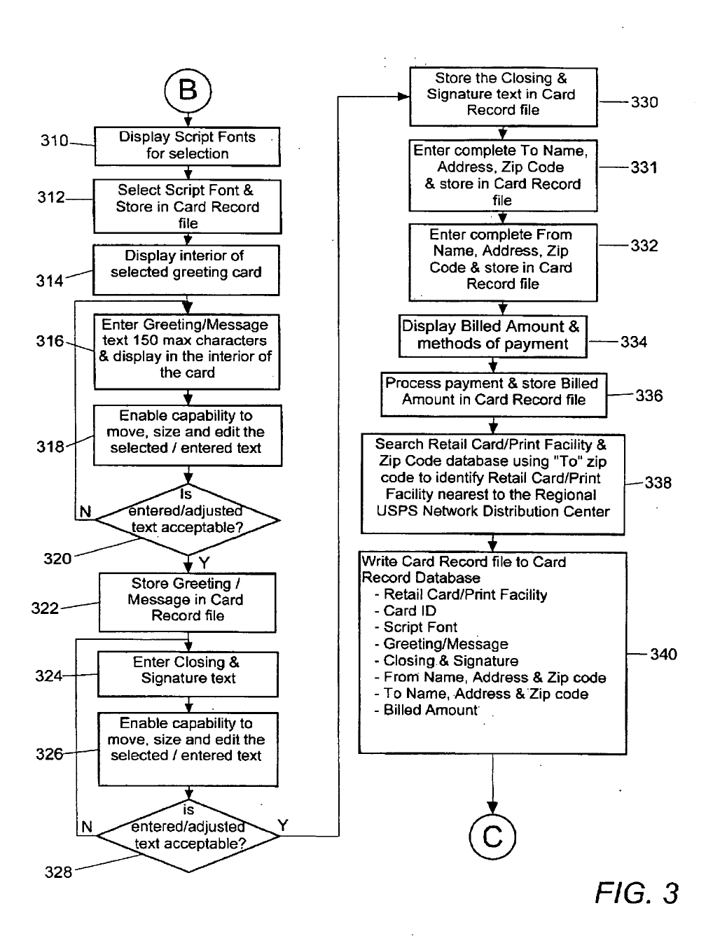

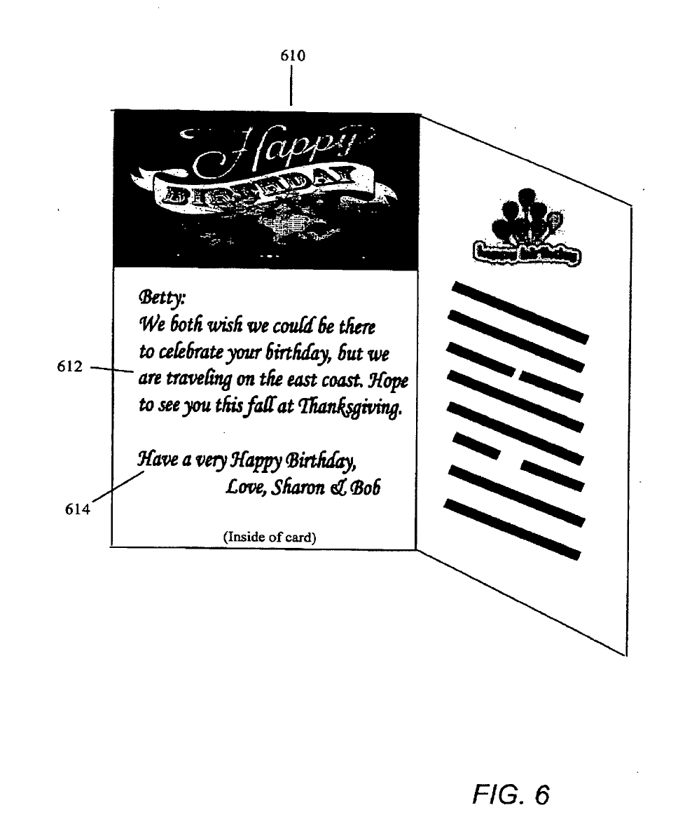

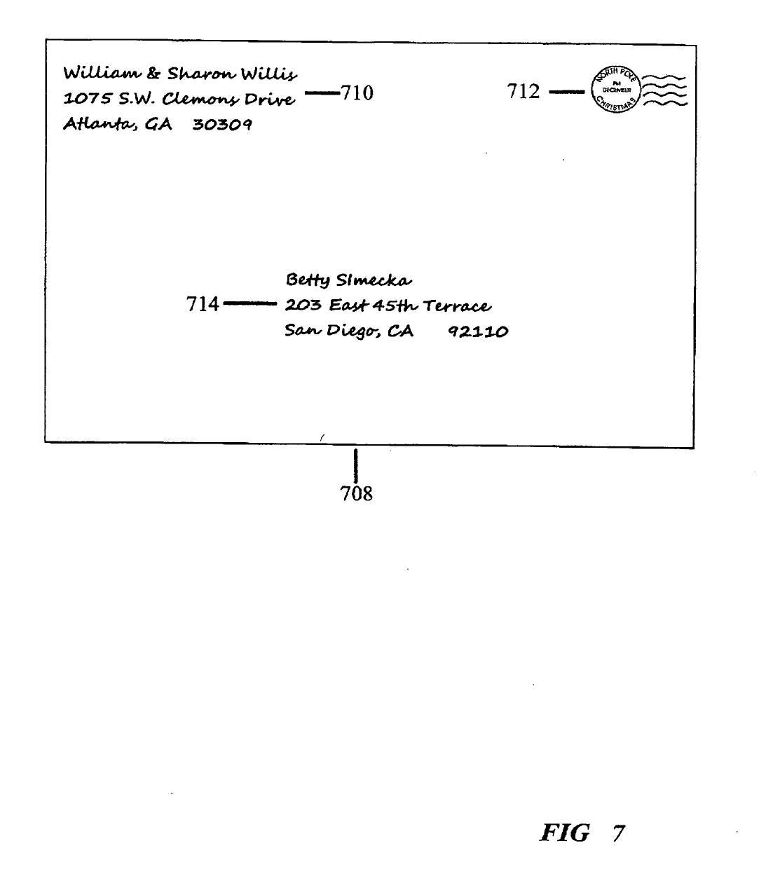

As minimized images 216, are scrolled and displayed, a greeting card image may be selected by the user and enlarged 218 for a more detailed viewing, with an option to also view the greeting card interior 220 or return to minimized scrolling 216. Upon selecting the currently viewed greeting card image 222, the selected card's Card-ID is used to create a Card-Record file 224. The list of available script fonts FIG. 3, 310 is displayed for selection, which will be used to display and ultimately print user entered text on the interior of the greeting card FIG. 6, 610, 612, 614 and the corresponding envelope FIG. 7, 708, 710, 714. The chosen script font is also stored in the Card-Record file 102, 312.

The interior of the greeting card is displayed 314 and the option of entering text as a Greeting/Message 316 of up to 150 characters is displayed, If text is entered, it is displayed on the user 108 screen (110-116) with an option to move and size the entered text to an open area of the card interior 318, 612. When the entered Greeting/Message text is accepted 320, it is stored in the Card-Record file 322. The user 108 is prompted to enter Closing & Signature text 324, of up to 50 characters, which is displayed on the user 108 screen (110-116), with the option to edit, adjust text size and location 326, and upon completion 328, is stored in the Card-Record file 102, 330.

Two other important elements to be entered are the complete To Name, Address and Zip code 331, and the complete From Name, Address and Zip code 332, which upon entry will be stored in the Card-Record file 102, 331, 332.

At this stage in the process, the greeting card price and any other charges are displayed with the acceptable methods of payment 334. Upon successful completion of payment processing the billed amount is stored in the Card-Record file 102, 336.

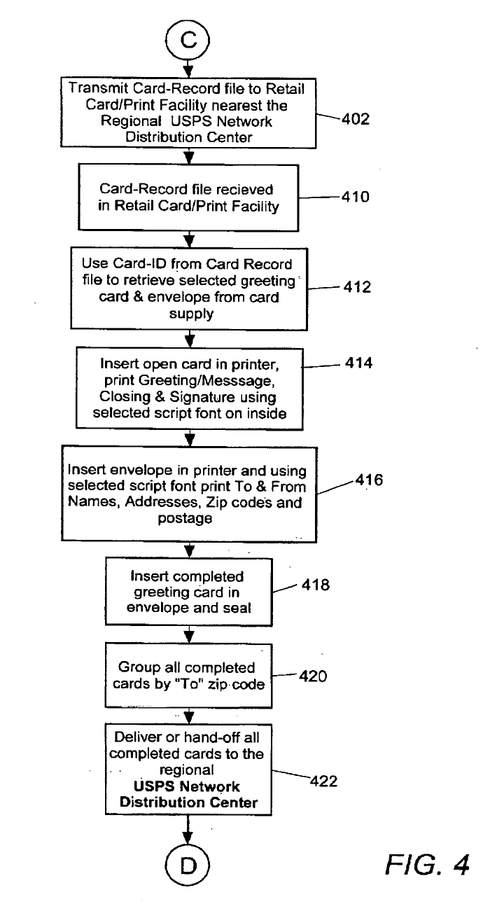

The “To” zip code from the Card-Record file 102 is used as the search element to query 338 the Retail Card/Print Facility & Zip Code Database 106, to determine the Retail Card/Print Facility which is in close proximity to the USPS Network Distribution Center serving the “To” zip code. The Retail Card/Print Facility is written to the Card Record file. The completed Card Record file 102, is written to the Card Record Database 104, 340. Based upon the preceding search, the Card-Record file is transmitted FIG. 4, 402 to the previously determined Retail Card/Print Facility for processing. Transmission time for the Card-Record file 102 over the internet or other data network will be approximately the same as that of a normal email transmission.

FIG. 4, 410 depicts receipt of the transmitted Card-Record file at the Retail Card/Print Facility located in close proximity to the USPS Network Distribution Center, which serves the “To” zip code. Based upon the Card-ID, from the transmitted Card-Record file 102, 402, the selected greeting card and companion envelope are retrieved from stock 412.

The user selected greeting card is inserted 414 in the printer in an open manner FIG. 610, where the Greeting/Message 612 and Closing & Signature 614 of the sender are printed. Next, the envelope FIG. 708 is placed in the printer 416 where the From 710 and To 714 Names, Addresses, Zip codes, postage 712 are printed. At this point the greeting card is inserted in the just printed envelope and sealed 418. The completed greeting card is placed in zip code order 420 with all other finished cards awaiting pick up by the USPS mail carrier 422 or local delivery by Retail Card/Print Facility personnel to the nearby regional USPS Network Distribution Center.

The addressed and zip code sorted greeting cards are received at the USPS Network Distribution Center FIG. 510, where they are processed and forwarded to the local post office 512 serving the card recipient. Upon receipt at the local destination post office 514, the greeting cards have been sorted and included with the regular mail that will also be received 516 by card recipients that day.

Throughout the foregoing description, for the purpose of explanation, numerous details were outlined in order to provide an understanding of the invention. It will be apparent, however, to one skilled in the art that the invention may be practiced with changes, substitutions and alterations to certain of these details without departing from the scope and spirit of the invention, as defined by the appended claims.

1-6. (canceled)

7. A method of expediting Greeting Cards, said method comprising:
(a) user access to a Web Site Application from a variety internet enabled devices for viewing and selection of said Greeting Card from a plurality of greeting card images, from a Greeting Card Image Database;
(b) creation of a Card Record file to contain data elements specific to each Greeting Card transaction;
(c) upon selection of said Greeting Card, the Card-ID of said Greeting card is stored in said Card Record file;
(d) receiving and storing user text input of sending party's complete Name, Address and From Zip code in said Card Record file;
(e) receiving and storing user text input of card recipients complete Name, Address and To Zip code in said Card Record file;
(f) receiving and storing user text input of sending party's Greeting/Message in said Card Record file;
(g) receiving and storing user text input of sending party's Closing & Signature in said Card Record file;
(h) receiving and storing user selected script font in said Card Record file;
(i) using said zip code of said card recipient as search argument of Retail Card/Print Facility & Zip Code Database, to identify the Retail Card/Print Facility in close proximity to USPS Network Distribution Center (NDC) serving said To Zip Code;
(j) store identified said Retail Card/Print Facility in said Card Record file;
(k) for said Greeting Card, store Billed Amount in Card Record file;
(l) said Card Record file transmitted to the identified said Retail Card/Print Facility;
(m) based upon said Card-ID, from said Card Record file, said Retail Card/Print Facility personnel retrieve said Greeting Card and corresponding envelope from stock;
(n) said Greeting Card is placed in printer in an open manner, whereby said Greeting/Message and said Closing & Signature from said Card Record file are printed on the interior of said Greeting Card using said script front and removed from printer;
(o) place said corresponding envelope in said printer so as to print said From and To Names and Addresses, and postage using said script font and remove said envelope from printer;

8. The method of claim 1, wherein the said Greeting Card after printing is inserted into completed said corresponding envelope and sealed.

9. A method of claim 1, wherein said Card ID, and all other stored user text input in said Card Record file is written to Card Record Database.

10. A method of claim 1, wherein completed greeting cards in said Greeting Card/Print Facility are arranged in said To Zip code order for pick up by USPS mail carrier for delivery to said USPS Network Distribution Center for processing and subsequent delivery to said card recipient.

11. A method of claim 1, wherein appropriate postage is printed on said corresponding envelope at the time of printing said To and From addresses.
